(19) United States
(12) Patent Application Publication
(10) Pub. No.: US 2008/0048799 A1
(43) Pub. Date: Feb. 28, 2008

(54) Discontinuous Transmission Line Structure

(76) Inventors: Chao-Wei Wang, Taichung City (TW); Tzyh-Ghuang Ma, Jhonghe City (TW); Chang-Fa Yang, Taipei City (TW)

Correspondence Address: HDSL, 4331 STEVENS BATTLE LANE, FAIRFAX, VA, 22033, US

(21) Appl. No.: 11/773,962

(22) Filed: Jul. 6, 2007

Related U.S. Application Data
(60) Provisional application No. 60/830,538, filed on Jul. 12, 2006.

(51) Int. Cl. H01P 1/18

(52) U.S. Cl. 333/156

(57) ABSTRACT

A discontinuous transmission line structure includes an input transmission line, an output transmission line, a plurality of meandered inductors, coupled in series between the input transmission line and the output transmission line, and a plurality of shunted to grounded capacitors, coupled between the meandered inductors. The discontinuous transmission line structure has a high inductance and a high capacitance, and can effectively reduce the size by increasing the transmission line load impedance and capacitance while the characteristic impedance of the transmission line structure remains.

### CROSS REFERENCE

The application claims the benefit of provisional application Ser. No. 60/830,538, filed Jul. 11, 2006.

### BACKGROUND

The present invention relates to a transmission line design, and more particularly to a “discontinuous transmission line”, which has elements of high inductance values and elements of high capacitance values.

With the growing popularity of mobile communication systems, beam scanning phase array antenna has become a key element for ensuring accuracy when communicating with users on the move. Similarly, in radio frequency identification (RFID) systems, when goods in storage are being moved around or are placed on a conveyer belt, beam scanning phase array antennas can be implemented to provide better efficiency of RFID readers. Bulter Matrix has an advantage of exactly controlling input signal strength and phase. By integrating Bulter Matrix control circuits to phase array antennas, the phase array antennas have a capability of beam scanning. Performances of RFID systems can be enhanced by incorporating the Bulter Matrix.

A control circuit for the Bulter Matrix phase array antennas includes four 3-dB branch line couplers, two 0-dB crossovers, and two transmission line sections for adjusting phases. The 3-dB branch line coupler has functions of equal power-splitting and quadrature phase control, and is used frequently in microwave circuits. The 3-dB branch line coupler is a key element of a Bulter Matrix circuit.

The implementation of the control circuit for an RFID system operating at 900 MHz has the disadvantage of a large occupied circuit size. The discontinuous transmission line technique can be applied to reduce the size of the circuit effectively. Based on the transmission line theory, a characteristic impedance, a phase velocity and a guided wave length can be calculated as the following:

Z₀=√(L/C)

vₚ=1/√(LC)

λ=vₚ/f

wherein Z₀ is the characteristic impedance, L is the per-unit-length transmission line inductance, C is the per-unit-length transmission line capacitance, vₚ is the electromagnetic wave phase velocity in a transmission line, f is the electromagnetic wave frequency, and λ is the guided wave length. When the transmission line inductance and capacitance increase simultaneously but the characteristic impedance remains at a specific value, the phase velocity and the corresponding guided wavelength can be reduced. By applying this relationship, circuits at low frequencies can be scaled down by increasing transmission line inductance and capacitance.

Referring to FIG. 1, which shows a discontinuous transmission line structure 100 of the prior art. The discontinuous transmission line structure 100 includes an input transmission line 110, an output transmission line 120, and a plurality of inductors L and capacitors (e.g. C₁ and C₂). The input transmission line 110, the output transmission line 120, the inductors L, and capacitors are formed by metal plates arranged on a substrate 101. The inductors L are connected in series and between the input transmission line 110 and the output transmission 120. A pair of capacitors C₁ and C₂ is shunted to ground and placed between two of the inductors L. The pair of capacitors C₁ and C₂ is connected symmetrically to each sides of every inductor L. The inductors L connected in series appear discontinuous to the input transmission line 110 and the output transmission line 120, and can increase the inductance value of the unit length line. The capacitors connected in series appear discontinuous as well while they are actually connected in parallel to the input transmission line 110 and the output transmission line 120, and can increase the capacitance value of the unit length line. The essence of the configuration is to place the inductors L and the capacitors alternatively between the input transmission line 110 and the output transmission line 120.

When the discontinuous transmission line 100 is applied to a 900 MHz RFID system, the 900 MHz RFID system with a 90-degree phase shift transmission line usually requires a layout area of approximately 30.8 mm by 4 mm. A 4-by-4 Bulter Matrix phase array antenna control circuit requires four 3-dB branch couplers, two sets of 0-dB crossovers, and two phase adjusting 45-degree transmission lines. Each of the four 3-dB branch couplers is constructed from four sections of a discontinuous transmission line. The 0-dB crossover is made of two 3-dB branch-line couplers. Therefore, there is a total amount of thirty-four segments of 90-degree or 45-degree phase shift discontinuous transmission lines. If sizes of the transmission lines are not properly scaled down, the resulting Butler Matrix phase array antenna will be too large for practical use and more vulnerable to additional wear.

A discontinuous transmission line structure, which has a high per-unit-length inductance value and a high per-unit-length capacitance value, is highly demanded. The discontinuous transmission line structure can effectively reduce the circuit size by simultaneously increasing the transmission line inductance and capacitance values while keeping the line characteristic impedance unaltered.

### BRIEF SUMMARY

One object of the present invention is to provide a discontinuous transmission line structure. The discontinuous transmission line structure includes an input transmission line; an output transmission line; a plurality of meandered inductors, coupled in series between the input transmission line and the output transmission line; and a plurality of shunted to grounded capacitors, coupled between the meandered inductors.

Another object of the present invention is to provide a discontinuous transmission line structure for providing a phase delay at a given characteristic impedance. The discontinuous transmission line structure includes an input transmission line; an output transmission line; and a capacitor-inductor combination circuit, coupled between the input transmission line and the output transmission line, wherein the capacitor-inductor combination circuit comprises a plurality of meandered inductors, and a plurality of shunted to grounded capacitors coupled between the meandered inductors; wherein the phase delay is determined by the meandered inductors and the shunted to grounded capacitors.

The discontinuous transmission line structures of the present invention are capable of forming transmission lines with a wide variety of characteristic impedances in a very compact size, and suppressing high frequency noise signals over a wide frequency range.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a conventional discontinuous transmission line.

FIG. 2A shows an equivalent circuit of a discontinuous transmission line structure in accordance with a first embodiment of the present invention.

FIG. 2B is a schematic view of the discontinuous transmission line structure of FIG. 2A.

FIG. 3A shows an equivalent circuit of a discontinuous transmission line structure in accordance with a second embodiment of the present invention.

FIG. 3B is a schematic view of the discontinuous transmission line structure of FIG. 3A.

FIG. 4A shows an equivalent circuit of a discontinuous transmission line structure in accordance with a third embodiment of the present invention.

FIG. 4B is a schematic view of the discontinuous transmission line structure of FIG. 4A.

FIG. 5A shows an equivalent circuit of a discontinuous transmission line structure in accordance with a fourth embodiment of the present invention.

FIG. 5B is a schematic view of the discontinuous transmission line structure of FIG. 5A.

FIG. 6 shows an equivalent circuit of a discontinuous transmission line structure in accordance with a fifth embodiment of the present invention.

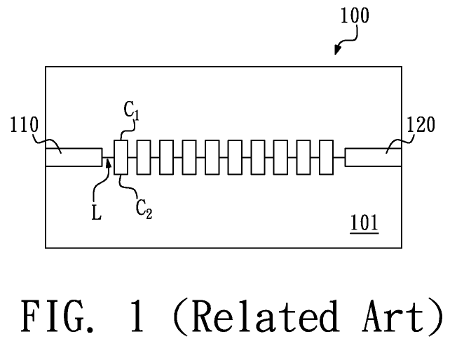

### DETAILED DESCRIPTION

A discontinuous transmission line structure which has specially arranged inductors and capacitors placed alternatively is provided while the characteristic impedance of the transmission line structure remains. The present invention is capable of reducing the phase velocity effectively so that the size is scaled down.

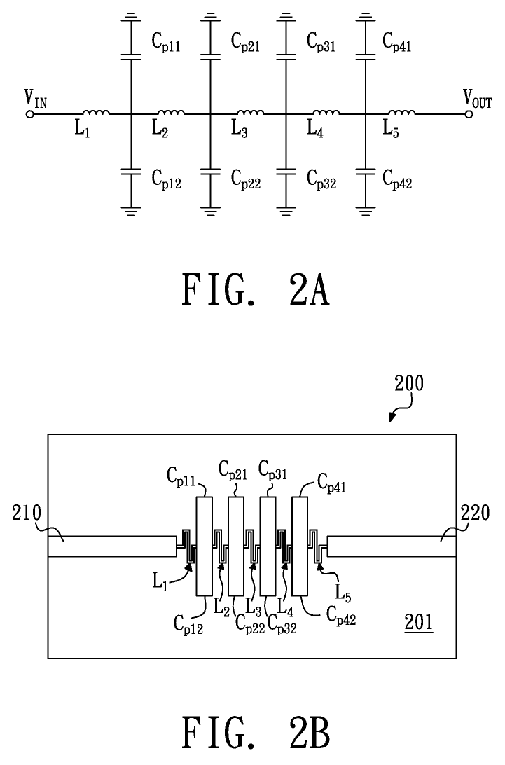

Referring to FIG. 2A, which shows an equivalent circuit of a discontinuous transmission line structure in accordance with a first embodiment of the present invention. The discontinuous transmission line structure includes a capacitor-inductor combination circuit comprising inductors L₁, L₂, L₃, L₄, and L₅, capacitors Cₚ₁₁, Cₚ₁₂, Cₚ₂₁, Cₚ₂₂, Cₚ₃₁, Cₚ₃₂, Cₚ₄₁, and Cₚ₄₂. The inductors L₁, L₂, L₃, L₄, and L₅ are connected in series between an input V_{IN} and an output V_{OUT}. A pair of the shunted to grounded capacitors Cₚ₁₁ and Cₚ₁₂ is connected between the inductors L₁, and L₂. Similarly, there are also a pair of the shunted to grounded capacitors Cₚ₂₁ and Cₚ₂₂ connected between the inductors L₂ and L₃, a pair of the shunted to grounded capacitors Cₚ₃₁ and Cₚ₃₂ connected between the inductors L₃ and L₄, and a pair of the shunted to grounded capacitors Cₚ₄₁ and Cₚ₄₂ connected between the inductors L₄ and L₅. One end of each of the shunted to grounded capacitors Cₚ₁₁, Cₚ₁₂, Cₚ₂₁, Cₚ₂₂, Cₚ₃₁, Cₚ₃₂, Cₚ₄₁, and Cₚ₄₂ is connected to the series of the inductors L₁, L₂, L₃, L₄, and L₅, and the other end is connected to ground.

Referring to FIG. 2B, which shows a design diagram of the discontinuous transmission line structure of FIG. 2A. The inductors L₁, L₂, L₃, L₄, L₅ and capacitors Cₚ₁₁, Cₚ₁₂, Cₚ₂₁, Cₚ₂₂, Cₚ₃₁, Cₚ₃₂, Cₚ₄₁, Cₚ₄₂ are formed by metal plates arranged on a substrate 201. The discontinuous transmission line structure 200 further includes an input transmission line 210, an output transmission line 220. The inductors L₁, L₂, L₃, L₄, and L₅ connected in series between the input transmission line 210 and the output transmission line 220. Each of the inductors L₁, L₂, L₃, L₄, and L₅ is meandered; namely the inductors L₁, L₂, L₃, L₄, and L₅ are meandered inductors. A feature of each pair of the shunted to grounded capacitors Cₚ₁₁, Cₚ₁₂, Cₚ₂₁, Cₚ₂₂, Cₚ₃₁, Cₚ₃₂, Cₚ₄₁, Cₚ₄₂ is a metal plate. In this embodiment, the input transmission line 210 and the output transmission line 220 are microstrip lines. The meandered inductors L₁, L₂, L₃, L₄, and L₅ are meandered wires for the purpose of obtaining a higher inductance value as well as saving a layout area. The shunted to grounded capacitors Cₚ₁₁, Cₚ₁₂, Cₚ₂₁, Cₚ₂₂, Cₚ₃₁, Cₚ₃₂, Cₚ₄₁, Cₚ₄₂ are grounded to the substrate 201 which is substantially one electrode plate of the capacitors Cₚ₁₁, Cₚ₁₂, Cₚ₂₁, Cₚ₂₂, Cₚ₃₁, Cₚ₃₂, Cₚ₄₁, Cₚ₄₂. Alternatively, an additional metal plate can be placed on the other side of the substrate 201 to provide the ground.

According to the first embodiment of the present invention, the phase velocity of signals passing through the transmission line structure 200 can be effectively reduced and the size of the circuit is scaled down.

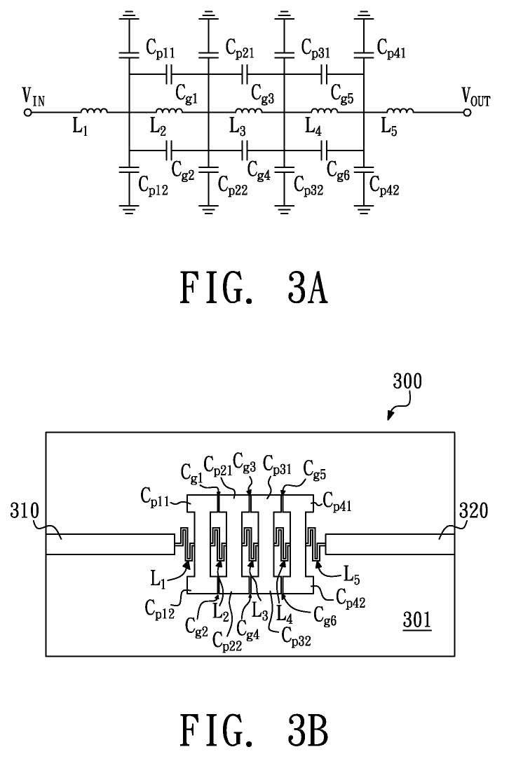

Referring to FIG. 3A, which shows an equivalent circuit of a discontinuous transmission line structure in accordance with a second embodiment of the present invention. Similar to the first embodiment, the second embodiment comprises the capacitor-inductor combination circuit comprising the inductors L₁, L₂, L₃, L₄, and L₅, the shunted to grounded capacitors Cₚ₁₁, Cₚ₁₂, Cₚ₂₁, Cₚ₂₂, Cₚ₃₁, Cₚ₃₂, Cₚ₄₁, Cₚ₄₂. The inductors L₁, L₂, L₃, L₄, and L₅ are connected in series between an input V_{IN} and the output V_{OUT}. The shunted to grounded capacitors Cₚ₁₁ and Cₚ₁₂ are connected between two inductors L₁ and L₂. The shunted to grounded capacitors Cₚ₂₁ and Cₚ₂₂ are connected between two inductors L₂ and L₃. The shunted to grounded capacitors Cₚ₃₁ and Cₚ₃₂ are connected between two inductors L₃ and L₄. The shunted to grounded capacitors Cₚ₄₁ and Cₚ₄₂ are connected between two inductors L₄ and L₅. Furthermore, the second embodiment comprises serial capacitors C_{g1}, C_{g2}, C_{g3}, C_{g4}, C_{g5}, and C_{g6}. The serial capacitors C_{g1} and C_{g2} are symmetrically arranged in different sides of the inductor L₂. That is, the serial capacitors C_{g1} and C_{g2} are connected in parallel to the inductor L₂. The second embodiment also acts as a low pass filter. The serial capacitors C_{g1} and C_{g2} provide a stop band transmission zero point to enhance frequency selectivity and suppress high frequency noise signals. Similarly, the serial capacitors C_{g3} and C_{g4} are connected in parallel to the inductor L₃, and the serial capacitors C_{g5} and C_{g6} are connected in parallel to the inductor L₄.

Referring to FIG. 3B, which shows a design diagram of the discontinuous transmission line structure 300 of FIG. 3A. Similar to the first embodiment, an input transmission line 310, an output transmission line 320 and the meandered inductors L₁, L₂, L₃, L₄, L₅, and the shunted to grounded capacitors Cₚ₁₁, Cₚ₁₂, Cₚ₂₁, Cₚ₂₂, Cₚ₃₁, Cₚ₃₂, Cₚ₄₁, Cₚ₄₂ are formed by metal plates sitting on a substrate 301. In the second embodiment, a feature of each pair of the shunted to grounded capacitors Cₚ₁₁, Cₚ₁₂, Cₚ₂₁, Cₚ₂₂, Cₚ₃₁, Cₚ₃₂, Cₚ₄₁, Cₚ₄₂ is an “I” shape. The meandered inductors L₂, L₃, L₄ are disposed among the “I” shapes. More specifically, each of the meandered inductors L₂, L₃, L₄ is disposed between two of the “I” shapes. The “I” shapes increase the capacitance of the shunted to grounded capacitors Cₚ₁₁, Cₚ₁₂, Cₚ₂₁, Cₚ₂₂, Cₚ₃₁, Cₚ₃₂, Cₚ₄₁, Cₚ₄₂. The serial capacitors C_{g1}, C_{g2}, C_{g3}, C_{g4}, C_{g5}, and C_{g6} are formed by metal plates sitting on a substrate 301. In practical manufacturing, the serial capacitors C_{g1}, C_{g2}, C_{g3}, C_{g4}, C_{g5}, and C_{g6} may be formed by the coupling effect of an adjunct pair of the shunted to grounded capacitors Cₚ₁₁, Cₚ₁₂, Cₚ₂₁, Cₚ₂₂, Cₚ₃₁, Cₚ₃₂, Cₚ₄₁, Cₚ₄₂. For example, the metal plates of Cₚ₁₁ and Cₚ₂₁ are also two electrodes of the serial capacitor C_{g1}. The substrate 301 and air are regarded as a dielectric layer of the capacitor C_{g1}. Similarly, the metal plates of Cₚ₂₁ and Cₚ₃₁ are also two electrodes of the serial capacitor C_{g3}, the metal plates of Cₚ₃₁ and Cₚ₄₁ are also two electrodes of the serial capacitor C_{g5}, the metal plates of Cₚ₁₂ and Cₚ₂₂ are also two electrodes of the serial capacitor C_{g2}, the metal plates of Cₚ₂₂ and Cₚ₃₂ are also two electrodes of the serial capacitor C_{g4}, and the metal plates of Cₚ₃₂ and Cₚ₄₂ are also two electrodes of the serial capacitor C_{g6}. These serial capacitors C_{g1}, C_{g2}, C_{g3}, C_{g4}, C_{g5}, and C_{g6} provide stop band zero transmission points, which enhance the performance of the frequency selection in the circuit.

Since the shunted to grounded capacitors Cₚ₁₁, Cₚ₁₂, Cₚ₂₁, Cₚ₂₂, Cₚ₃₁, Cₚ₃₂, Cₚ₄₁, Cₚ₄₂ are integrated with the meandered inductors L₁, L₂, L₃, L₄, L₅ in the manner described above and shown in FIG. 3B, the phase velocity of the second embodiment is reduced and the transmission line circuit can be scaled down.

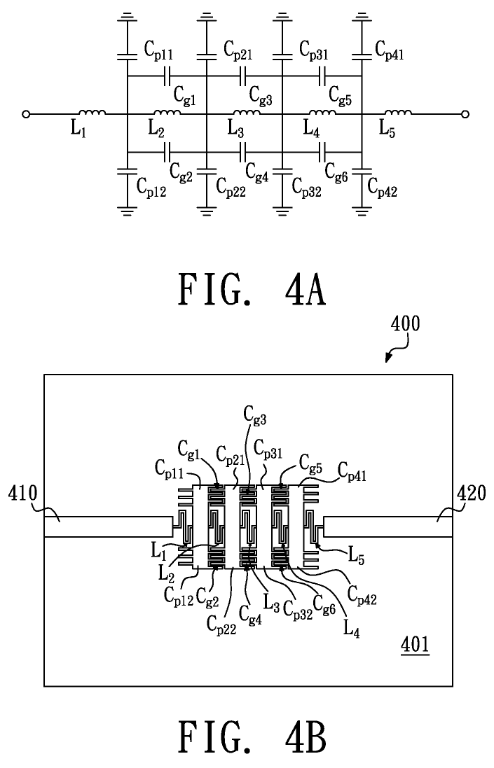

Now refer to FIG. 4A, and FIG. 4B. FIG. 4A shows an equivalent circuit of a discontinuous transmission line structure in accordance with a third embodiment of the present invention. FIG. 4B shows a design diagram of the discontinuous transmission line structure 400 of FIG. 4A. The discontinuous transmission line structure shown in FIG. 4A is identical to that shown in FIG. 3A. In contrast with the second embodiment, both ends of two adjacent “I” shaped shunted to grounded capacitors of the third embodiment are interdigital as shown in FIG. 4B. The interdigital shapes, forming the serial capacitors C_{g1}, C_{g2}, C_{g3}, C_{g4}, C_{g5}, and C_{g6}, increases the surface area of the electrodes thereof. The increased metal surface area leads to an increase in capacitance. Such higher capacitance further enhances the performance of the stop band selection of the circuit. The design also increases the capacitance of the shunted to grounded capacitors Cₚ₁₁, Cₚ₁₂, Cₚ₂₁, Cₚ₂₂, Cₚ₃₁, Cₚ₃₂, Cₚ₄₁, Cₚ₄₂.

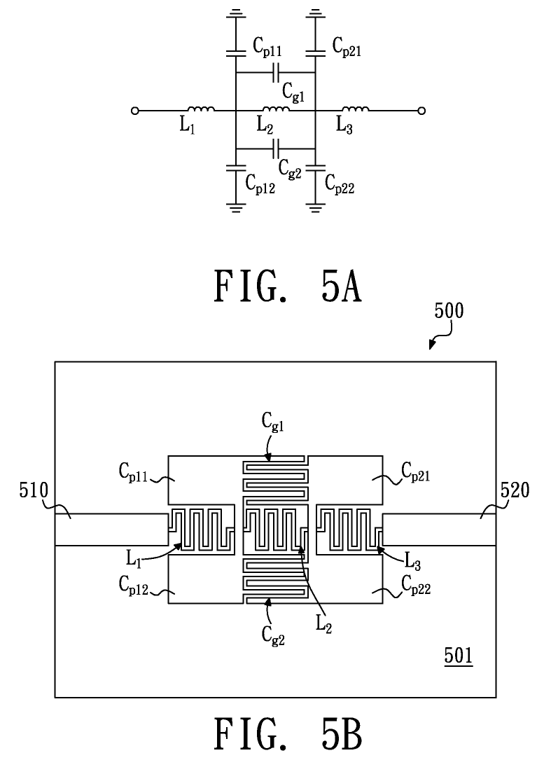

FIG. 5A shows an equivalent circuit of a discontinuous transmission line structure in accordance with a fourth embodiment of the present invention. The fourth embodiment includes a capacitor-inductor combination circuit comprising inductors L₁, L₂, L₃, shunted to grounded capacitors Cₚ₁₁, Cₚ₁₂, Cₚ₂₁, Cₚ₂₂, and serial capacitors C_{g1}, C_{g2}. The inductors L₁, L₂, L₃ are connected in series between the input and the output of the discontinuous transmission line structure. A pair of shunted to grounded capacitors Cₚ₁₁ and Cₚ₁₂ is connected between the inductors L₁ and L₂. The other pair of shunted to grounded capacitors Cₚ₂₁ and Cₚ₂₂ is connected between two inductors L₂ and L₃. Each of the shunted to grounded capacitors Cₚ₁₁, Cₚ₁₂, Cₚ₂₁, Cₚ₂₂ has one end connected to the inductors L₁, L₂, L₃, and the other end connected to the ground. The serial capacitors C_{g1} and C_{g2} are symmetrically arranged in different sides of the inductor L₂. The serial capacitors C_{g1}, C_{g2}, and the inductor L₂ form a resonator, which provides transmission zero point to provide frequency selectivity capability to the circuit.

Referring to FIG. 5B, which shows a design diagram of the discontinuous transmission line structure 500 of FIG. 5A, which is similar to a combination of the second embodiment and the third embodiment. An input transmission line 510, an output transmission line 520, the meandered inductors L₁, L₂, L₃, and the shunted to grounded capacitors Cₚ₁₁, Cₚ₁₂, Cₚ₂₁, Cₚ₂₂ are formed by metal plates sitting on a substrate 501. The serial capacitors C_{g1}, C_{g2} are formed by the interdigital ends of the shunted to grounded capacitors Cₚ₁₁, Cₚ₁₂, Cₚ₂₁, Cₚ₂₂. The interdigital structure is similar to the corresponding part of the third embodiment.

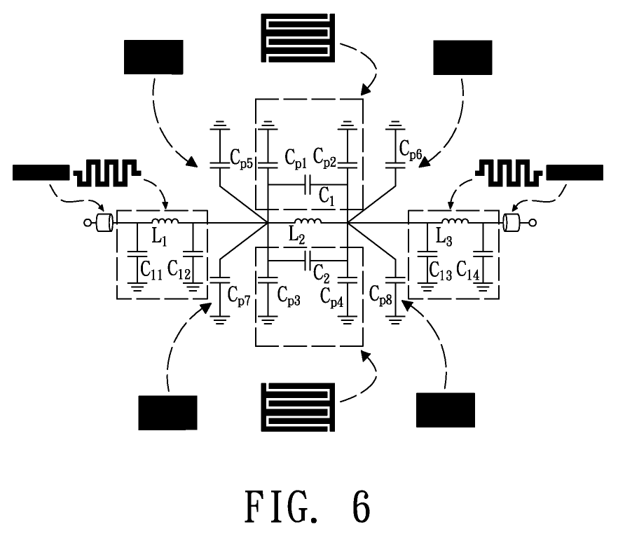

FIG. 6 shows an equivalent circuit of a discontinuous transmission line structure in accordance with a fifth embodiment of the present invention. The fifth embodiment includes a capacitor-inductor combination circuit comprising meandered inductors L₁, L₂, L₃, shunted to grounded capacitors Cₚ₁, Cₚ₂, Cₚ₃, Cₚ₄, Cₚ₅, Cₚ₆, Cₚ₇, Cₚ₈, C₁₁, C₁₂, C₁₃, C₁₄, and serial capacitors C₁, C₂. The meandered inductors L₁, L₂, L₃ are connected in series between the input and the output of the discontinuous transmission line structure. The two pairs of shunted to grounded capacitors Cₚ₁, Cₚ₃, Cₚ₅, Cₚ₇ are connected to one end of the meandered inductor L₂, and the two pairs of shunted to grounded capacitors Cₚ₂, Cₚ₄, Cₚ₆, Cₚ₈ are connected to the other end of the meandered inductor L₂. The serial capacitor C₁ is connected between the shunted to grounded capacitors Cₚ₁ and Cₚ₂. The serial capacitor C₂ is connected between the shunted to grounded capacitors Cₚ₃ and Cₚ₄. The serial capacitors C₁ and C₂ are parallel to the meandered inductor L₂, and formed by the interdigital ends of the shunted to grounded capacitors Cₚ₁, Cₚ₂, Cₚ₃, Cₚ₄. The shunted to grounded capacitors Cₚ₅, Cₚ₆, Cₚ₇, Cₚ₈ are formed simply by rectangular metal plates. Each of the shunted to grounded capacitors Cₚ₁, Cₚ₂, Cₚ₃, Cₚ₄, Cₚ₅, Cₚ₆, Cₚ₇, and Cₚ₈ has one end connected to ground. The meandered inductors L₁, L₂, L₃ represent meandered-line inductors, while the parasitic capacitance of the meandered inductors L₁ and L₃ can be accounted for the shunted to grounded capacitors C₁₁, C₁₂, C₁₃, C₁₄. The shunted to grounded capacitors Cₚ₅, Cₚ₆, Cₚ₇, and Cₚ₈ are implemented with microstrip parallel-plated capacitors, which are in parallel with the shunted to grounded capacitors Cₚ₁, Cₚ₂, Cₚ₃, and Cₚ₄.

Each of the discontinuous transmission line structures of the above embodiments includes LC networks. Each LC network provides high inductance and high capacitance. The configuration can reduce the phase velocity of signals traveling through the discontinuous transmission line structures of the present invention. The amount of phase velocity reduction can be adjusted by tuning the LC values or by changing the number of LC elements in the network. The discontinuous transmission line structures of the present invention can be applied to couplers, phase shifters, feedback lines and balun circuits to reduce the size of the circuit. The frequency selectivity capability and the harmonic suppression characteristic of the discontinuous transmission line structures are determined by the serial capacitors coupled between the shunted to grounded capacitors and in parallel to the meandered inductors.

The meandered inductors of the present invention may be folded-strips inductors, each of which includes a plurality of metal strips for folded connecting to each other. With more folds, the meandered inductors of the present invention may have higher inductances. The metal plate surface area should be increased if more capacitances to the capacitors are intended to be obtained.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A discontinuous transmission line structure comprising:
an input transmission line;
an output transmission line;
a plurality of meandered inductors, coupled in series between the input transmission line and the output transmission line; and
a plurality of shunted to grounded capacitors, coupled between the meandered inductors.

2. The discontinuous transmission line structure of claim 1, further comprising a plurality of serial capacitors coupled between the shunted to grounded capacitors and in parallel to the meandered inductors.

3. The discontinuous transmission line structure of claim 1, wherein a pair of the shunted to grounded capacitors is located at different sides of the meandered inductors, one end of each of the shunted to grounded capacitors is coupled to one of the meandered inductors, and the other end of each of the shunted to grounded capacitors is grounded.

4. The discontinuous transmission line structure of claim 3, wherein a feature of the pair of the shunted to grounded capacitors is a plate.

5. The discontinuous transmission line structure of claim 3, wherein the pair of the shunted to grounded capacitors has an “I” shape.

6. The discontinuous transmission line structure of claim 5, wherein the meandered inductors are disposed among the “I” shapes.

7. The discontinuous transmission line structure of claim 5, further comprising a plurality of serial capacitors coupled between the shunted to grounded capacitors and in parallel to the meandered inductors, wherein the serial capacitors are formed by two corresponding ends of two adjacent ones of the “I” shapes.

8. The discontinuous transmission line structure of claim 5, wherein one end of the “I” shape is interdigital.

9. The discontinuous transmission line structure of claim 8, further comprising a plurality of serial capacitors coupled between the shunted to grounded capacitors and in parallel to the meandered inductors, wherein the serial capacitors are formed by the two adjacent interdigital ends.

10. The discontinuous transmission line structure of claim 1, further comprising:
a substrate for placing the input transmission line, the output transmission line, the meandered inductors, and the shunted to grounded capacitors; and
a ground plate disposed under the substrate.

11. A discontinuous transmission line structure for providing a phase delay at a given characteristic impedance, the discontinuous transmission line structure comprising:
an input transmission line;
an output transmission line; and
a capacitor-inductor combination circuit, coupled between the input transmission line and the output transmission line, wherein the capacitor-inductor combination circuit comprises a plurality of meandered inductors, and a plurality of shunted to grounded capacitors coupled between the meandered inductors;
wherein the phase delay is determined by the meandered inductors and the shunted to grounded capacitors.

12. The discontinuous transmission line structure of claim 11, wherein the capacitor-inductor combination circuit further comprises a plurality of serial capacitors coupled between the shunted to grounded capacitors and in parallel to the meandered inductors, wherein a frequency selectivity capability and a harmonic suppression characteristic of the discontinuous transmission line structure are determined by the serial capacitors.

13. The discontinuous transmission line structure of claim 11, wherein a pair of the shunted to grounded capacitors is located at different sides of the meandered inductors, one end of each of the shunted to grounded capacitors is coupled to one of the meandered inductors, and the other end of each of the shunted to grounded capacitors is grounded.

14. The discontinuous transmission line structure of claim 13, wherein a feature of the pair of the shunted to grounded capacitors is a plate.

15. The discontinuous transmission line structure of claim 13, wherein the pair of the shunted to grounded capacitors has an “I” shape.

16. The discontinuous transmission line structure of claim 15, wherein the meandered inductors are disposed among the “I” shapes.

17. The discontinuous transmission line structure of claim 15, wherein the capacitor-inductor combination circuit further comprises a plurality of serial capacitors coupled between the shunted to grounded capacitors and in parallel to the meandered inductors, wherein the serial capacitors are formed by two corresponding ends of two adjacent ones of the “I” shapes.

18. The discontinuous transmission line structure of claim 15, wherein a feature of an end of the “I” shape is interdigital.

19. The discontinuous transmission line structure of claim 18, wherein the capacitor-inductor combination circuit further comprises a plurality of serial capacitors coupled between the shunted to grounded capacitors and in parallel to the meandered inductors, wherein the serial capacitors are formed by two adjacent interdigital ends of the “I” shapes.

20. The discontinuous transmission line structure of claim 11, further comprising:
a substrate for placing the input transmission line, the output transmission line, the meandered inductors, and the shunted to grounded capacitors; and
a ground plate disposed under the substrate.
